(19) United States
(12) Patent Application Publication
(10) Pub. No.: US 2022/0093066 A1
(43) Pub. Date: Mar. 24, 2022

(54) SYSTEM AND METHOD FOR CONTROL OF OFF-INSTRUMENT EFFECTS

(71) Applicants: Steven B. Savage, Peterborough, NH (US); Harris Flaum, Brookline, NH (US)

(72) Inventors: Steven B. Savage, Peterborough, NH (US); Harris Flaum, Brookline, NH (US)

(21) Appl. No.: 17/387,555

(22) Filed: Jul. 28, 2021

Related U.S. Application Data
(60) Provisional application No. 63/112,740, filed on Nov. 12, 2020.
(60) Provisional application No. 63/082,639, filed on Sep. 24, 2020.

(51) Int. Cl. G10D 3/13; G10D 1/08; G10H 3/14

(52) U.S. Cl. CPC G10D 3/13; G10H 3/143; G10D 1/085

(57) ABSTRACT

A string instrument tailpiece system, a retrofit kit, and method for control of an off-instrument signal processor are disclosed. The system includes a tailpiece and a control bar having an end portion configured to be received in a socket on the stringed instrument and rotatable about an axis of rotation. A magnet is attached to the end portion of the control bar. A sensor chip in or adjacent the socket is spaced from the magnet by a gap sufficiently small to enable the sensor chip to detect a change in the magnetic field due to a rotation of the control bar. A sensor circuit outputs a control signal based on a change in the magnetic field resulting from rotating the control bar, where the control signal is separate from the audio signal of the instrument.

### RELATED APPLICATIONS

This application claims the benefit under 35 U.S.C. § 119(e) of U.S. Provisional Patent Application No. 63/082,639, titled VIBRATO BAR ASSEMBLY AND METHOD FOR STRINGED INSTRUMENTS, filed on Sep. 24, 2020; and of U.S. Provisional Patent Application No. 63/112,740, titled SYSTEM AND METHOD FOR CONTROL OF OFF-INSTRUMENT EFFECTS, filed on Nov. 12, 2020, the contents of which are incorporated herein by reference in their entireties.

### BACKGROUND

The present disclosure relates generally to components and hardware for stringed musical instruments and more particularly to a control bar assembly, system, and method of controlling an effects unit that is distinct from a stringed instrument.

Stringed instruments, particularly electric guitars, have been equipped with various types of bridges and tailpieces since the instrument was introduced. Tailpiece assemblies developed by Bigsby and Fender include a vibrato bar that allows the player to effect vibrato and pitch changes by moving the vibrato bar up or down relative to the top surface of the guitar body to adjust the string tension. FIG. 1 is a cross-sectional diagram of part of a guitar and illustrates one type of prior-art vibrato tailpiece 8 that includes a vibrato block 11 connected to a bridge plate 10. The vibrato block 11 extends transversely from the bottom side of a bridge plate 10 into a cavity 19 defined in the body 4 of the guitar 5, with a bottom portion 11a connecting to springs 28 that extend and connect to guitar body 4. The bridge plate 10 can pivot about pivot point 17 with springs 28 pulling against the force of string tension. A vibrato bar 18, also known as a whammy bar or tremolo bar, engages the vibrato block 11 with a first end 20 of the vibrato bar 18 being inserted into the vibrato block 11 through the bridge plate 10. The user can use the vibrato bar 18 to pivot the vibrato block 11 and bridge plate 10 about a forward mounting screw to change tension on the strings 6. Accordingly, the pitch can be altered for scoops, dives, or a subtle vibrato effect. In addition to moving up and down in a rocking motion 22 relative to the top face 4a of the guitar body 4, the vibrato bar 18 can rotate about the first end 20 in a 360-degree circular motion 24 as viewed looking at top face 4a of the guitar body 4. The circular, rotational motion allows the player to hold the vibrato bar 18 as the player's hand moves across the strings as well as allowing the vibrato bar 18 to swing away from the strings 6 when vibrato bar 18 is not in use.

FIG. 2 illustrates another type of vibrato tailpiece 40 that includes a frame 41 that can be screwed to the guitar body. Strings (not shown) attach to and wrap over a first rod 42 and then pass under a guide rod 44 before extending across a bridge (not shown) on their way to the headstock (not shown). A vibrato bar 46 attaches to a mounting bracket 48 connected to the end of first rod 42. A spring 28 biases vibrato bar 46 to a position over guitar body and in balance with string tension. The player can position the vibrato bar 46 by rotating it about a fastener 52 that secures the vibrato bar 46 to the mounting bracket 48. The player can change the string tension, and therefore pitch, by pulling up or pushing down on vibrato bar 46 relative to the guitar body to rotate first rod 42 where the strings attach.

In addition to using a vibrato tailpiece for pitch changes, guitarists sometimes also use the volume knob or a volume pedal to produce volume effects, such as swells and fade-ins. The guitarist typically plucks the strings while at the same time using the little finger to rotate the guitar's volume knob. Because the volume knob is often positioned to be out of the way of the strumming hand, plucking the strings and adjusting the volume at the same time is difficult to do. Even more difficult is using the vibrato bar for a combination of pitch changes and volume changes performed all while picking or strumming. For the guitarist who uses a foot to control other effects pedals, such as a wah-wah pedal, a foot-controlled volume pedal is poor option since the foot is already occupied with controlling another pedal.

Therefore, what is needed is an assembly for guitars and other stringed instruments that provides another option for plucking the strings while also adjusting pitch and/or the volume.

### SUMMARY

Prior art tailpiece assemblies enable the user to modify pitch of a stringed instrument by using the vibrato bar, for example, as a lever to pivot the tailpiece to tighten or loosen the string tension and therefore affect the pitch. However, the sweeping or rotating motion of the vibrato bar has not been implemented as a movement to control the guitar signal. It would be desirable to use the sweeping or rotating movement of a control bar to generate a control signal which is transmitted to an off-instrument processor and used to control the effects output of the processor. Similarly, it would be desirable to use the control bar as an onboard expression device when coupled with an off-board effects pedal or processor. For example, the processor can be a foot pedal, a rack-mounted effects processor, or an effects processor built into an instrument amplifier. Further, it would be desirable to use a control bar for instruments equipped with a fixed bridge, where the player can move the bar in a sweeping or rotating motion to modulate a control signal. The present disclosure addresses these needs and others.

In accordance with one embodiment, a tailpiece is configured such that movement of the control bar changes an output signal that is used to control off-instrument effects, such as a signal processor, foot pedal, or other effects unit. Optionally, the control signal can also or alternately be used to affect the volume or tone of the instrument's audio output signal. In one example, the tailpiece system includes a tailpiece with a control bar. The control bar has an end portion that is received in a socket and that is rotatable about an axis of rotation. For example, the socket is defined in the tailpiece or in the guitar body. When the control bar is inserted into the socket, a magnet on the end of the control bar is positioned sufficiently close to a sensor chip that is sensitive to a change in the magnet's magnetic field. Rotating the control bar causes a change in a magnetic field, such as the field direction. In turn, a circuit coupled to the magneto-resistance chip outputs a control signal that can be directed to an off-instrument effects processor or to additional circuitry in the instrument that affects the instrument's tone, volume, or both. In one example embodiment, the control signal can be output via a stereo audio jack, where the other terminals of the jack include a ground pin and an audio signal output.

In some embodiments, the control bar is mounted to the instrument body next to a fixed bridge or installed into a socket that is part of the fixed bridge. For example, a socket can be installed into the guitar body to receive the control bar. In another example, the socket is part of a fixed bridge or a fastener used to mount the bridge to the instrument. In some such embodiments the control bar may not affect string tension, such as when the control bar is used with a fixed bridge without tremolo capability. Regardless of whether the tailpiece is configured for a tremolo effect, rotating the control bar modulates a control signal that can be sent to an effects processor, expression pedal input, or the like to change one or more parameters of an effect, such as volume, chorus depth, reverb level, delay time, or any other effects parameter.

In some embodiments, the control bar is part of a retrofit kit that includes a socket and control circuit configured to be installed on a stringed instrument having an existing tailpiece. For example, the control bar and circuit can be added to guitars having a fixed (non-tremolo) tailpiece so that the control bar can be used to modulate a control signal for controlling off-instrument effects.

The control bar of the present disclosure is described with reference to an electric guitar for ease of understanding. However, embodiments of the present disclosure are not limited to an electric guitar and can be used with a bass guitar, a ukulele, a pedal steel or lap steel guitar, or other solid-body or hollow-body instrument.

Note also that the control bar as variously described herein is not limited to this particular terminology and can also be referred to as a vibrato bar, a tremolo bar, a “whammy” bar, an expression bar, or other terms. The control bar may be used to change string tension in some embodiments and therefore may be also referred to as a vibrato bar. Numerous variations and embodiments will be apparent in light of the present disclosure.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the disclosed subject matter.

### BRIEF DESCRIPTION OF THE DRAWINGS

FIG. 1 is a side sectional view showing part of an electric guitar body with a prior-art tailpiece installed in the guitar body, in accordance with an embodiment of the present disclosure.

FIG. 2 is a perspective view of a tailpiece of the prior art, in accordance with another embodiment of the present disclosure.

FIG. 3A is a front view of a guitar body showing a tailpiece system installed on the guitar body, in accordance with an embodiment of the present disclosure.

FIG. 3B is a front view of part of a guitar equipped with a fixed tailpiece and a control bar mounted to the instrument body adjacent the tailpiece, in accordance with an embodiment of the present disclosure.

FIG. 4 is a perspective view the tailpiece of FIG. 3 showing a magnet and sensor chip disposed in the vibrato block, in accordance with an embodiment of the present disclosure.

FIG. 5 is a perspective view showing part of the control bar and sensor chip assembly of FIG. 4, in accordance with an embodiment of the present disclosure.

FIG. 6 is a perspective view of a control bar and mounting bracket configured for use with the vibrato tailpiece of FIG. 2, in accordance with an embodiment of the present disclosure.

FIG. 7 is a perspective view of a control bar configured for use with the mounting bracket and tailpiece of FIG. 2, in accordance with another embodiment of the present disclosure.

FIG. 8 is a diagram of a sensor circuit coupled to a sensor chip, where the control signal output from the circuit is based at least in part on the direction of the applied magnetic field, in accordance with an embodiment of the present disclosure.

FIG. 9 is a diagram of a sensor circuit coupled to a Hall Effect sensor chip, where the control signal output from the circuit is based at least in part on the strength of the applied magnetic field, in accordance with an embodiment of the present disclosure.

FIG. 10 is a diagram of a sensor circuit that can be used to adjust the instrument's tone using voltage from a magnetic sensor chip, in accordance with an embodiment of the present disclosure.

FIG. 11 illustrates a method of controlling an instrument output signal, in accordance with an embodiment of the present disclosure.

FIG. 12 illustrates a method of controlling an off-instrument signal processor, in accordance with an embodiment of the present disclosure.

The figures depict various embodiments of the present disclosure for purposes of illustration only. Numerous variations, configurations, and other embodiments will be apparent from the following detailed discussion.

### DETAILED DESCRIPTION

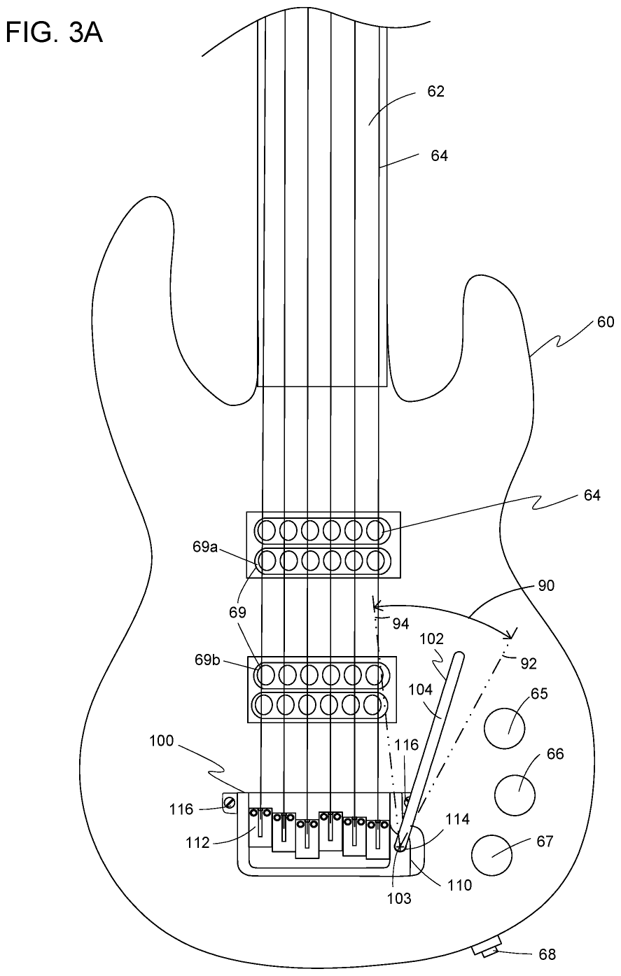

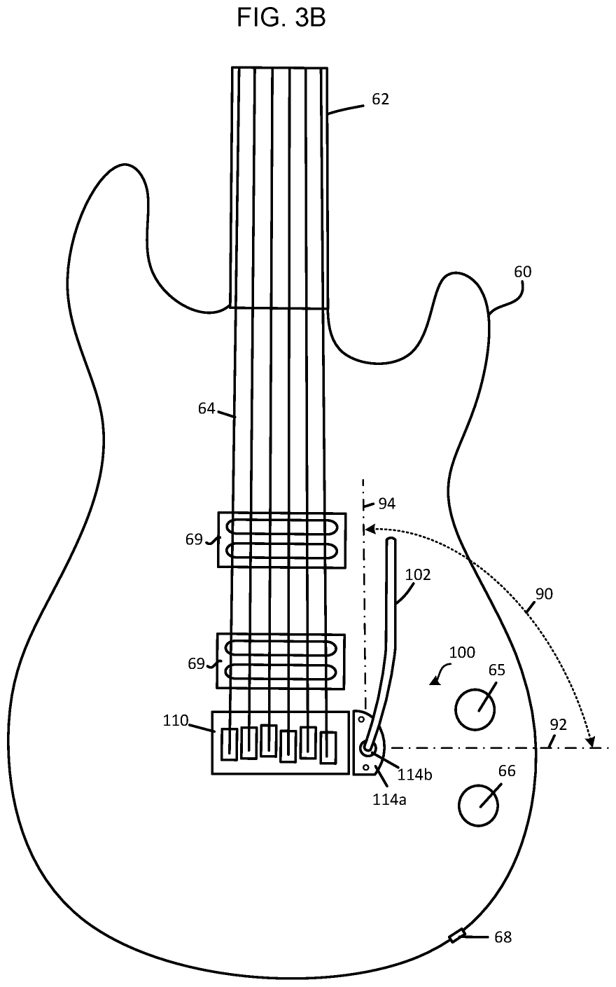

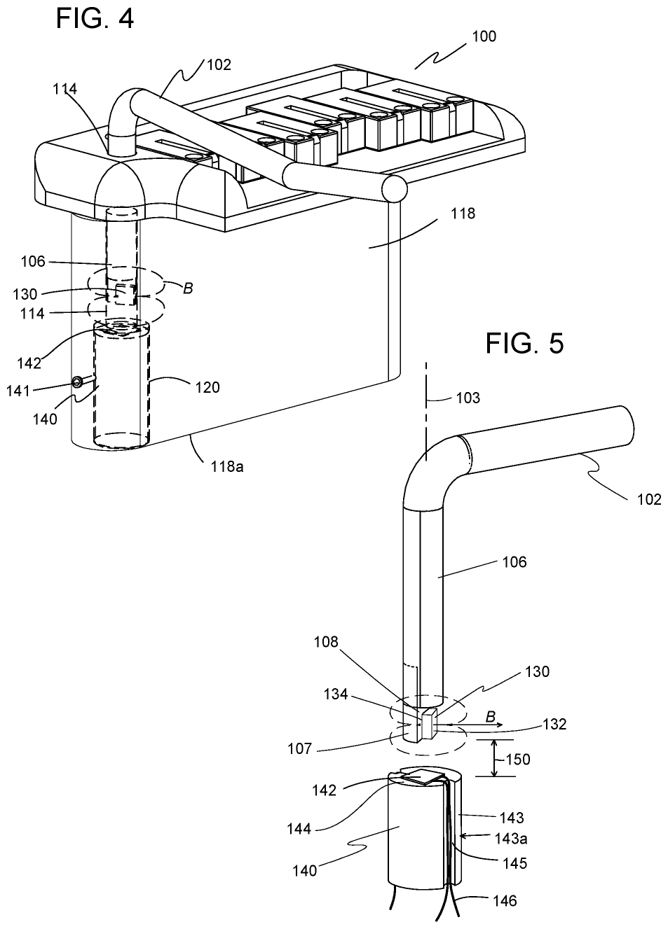

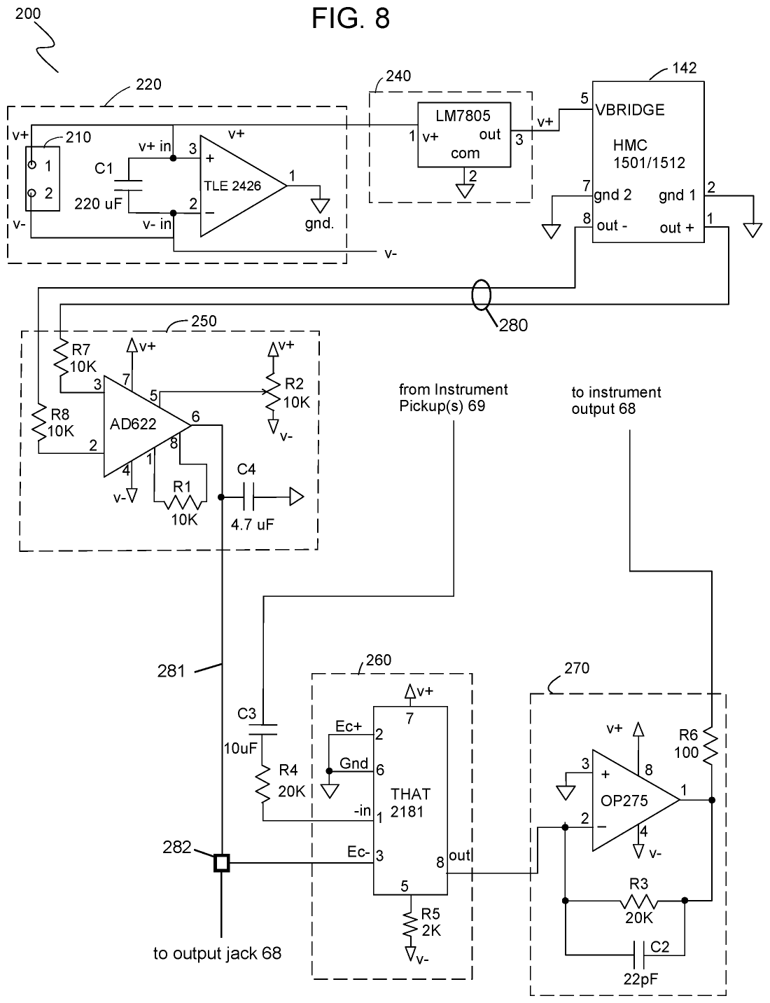

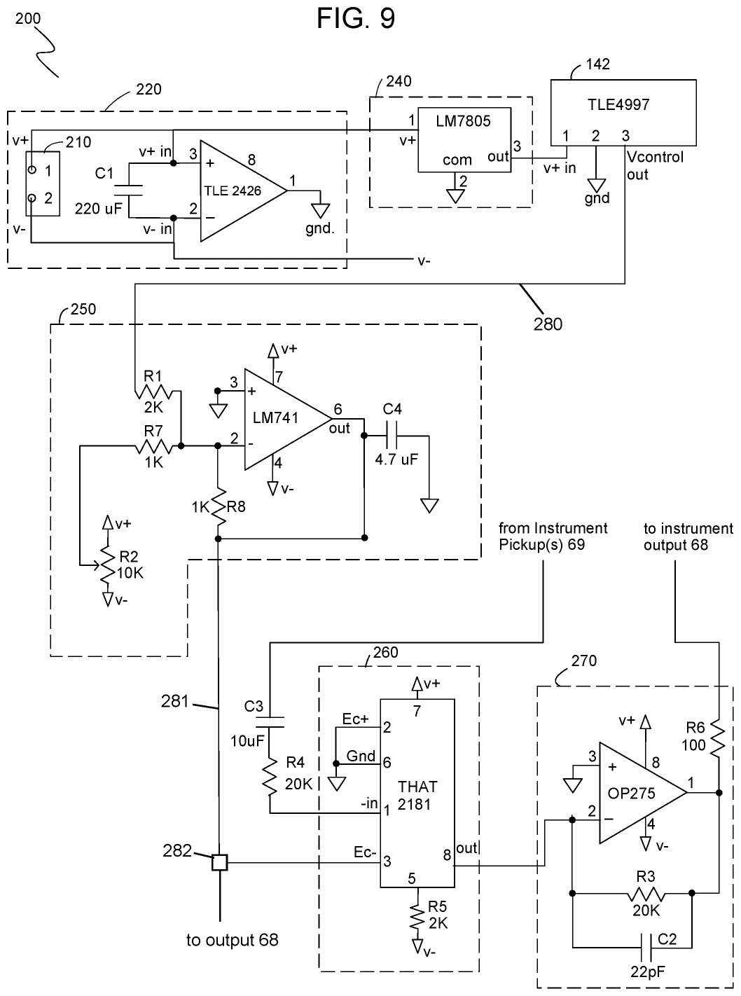

Example embodiments of the present disclosure are illustrated in FIGS. 3-12. FIG. 3A illustrates a front view of a guitar body 60 equipped with a tailpiece system 100 and a control bar, in accordance with one embodiment. A portion of a guitar neck 62 and strings 64 are also shown. Tailpiece system 100 includes a tailpiece 110, a control bar 102, a sensor chip 142 (shown in FIGS. 4-9), and a sensor circuit 200 (shown in FIGS. 8-9) with a sensor chip 142. The sensor chip 142 and sensor circuit 200 are discussed in more detail below. In some embodiments, tailpiece 110 also includes a bridge 112. The tailpiece 110 can be a vibrato tailpiece or a fixed tailpiece.

The guitar body 60 has an electronics group 63 that includes one or more pickups 69 and an output 68 connector. The instrument's electronics group 63 may be as simple or as complex as desired. For example, a simple embodiment of guitar electronics group 63 includes a single pickup 69 wired to an output 68 connector, which is typically a ¼″ audio jack. Additional controls are optional and include a volume potentiometer 65, tone potentiometer 66, pickup selection switch or pickup blend potentiometer 67, and the like. These additional controls can be included in the electronics group 63 as desired. The electronics group 63 of FIG. 3 includes pickups 69, including a neck pickup 69a and bridge pickup 69b. The pickups 69 are wired to a volume potentiometer 65, a tone potentiometer 66, a pickup blend potentiometer 67, and output 68 connector. The electronics group 63 can be electrically coupled to sensor circuit 200 of tailpiece system 100 as discussed in more detail below. The volume potentiometer 65 optionally includes a push/pull switch to bypass use of sensor circuit 200. Other bypass switches are also acceptable, such as a toggle switch. In some embodiments, the output 68 is a mono audio jack. In other embodiments, the output 68 is a stereo jack. For example, one terminal of the stereo jack used for the instrument's audio signal and the other terminal of the stereo jack used for a control signal.

The control bar 102 has an arm portion 104 and a stem or end portion 106 (shown in FIG. 4.) In some embodiments, end portion 106 is installed in or attached to a socket 114 that is part of the tailpiece 110 and rotates about an axis of rotation 103 that is oriented transverse (e.g., perpendicular) to the guitar body 60. In other embodiments, the socket 114 is separate from the tailpiece, such as when the tailpiece is a fixed tailpiece and the socket 114 is part of a retrofit kit. In one embodiment, the end portion 106 extends transversely from arm portion 104 and is constructed for insertion into a socket 114 in tailpiece 110 or in the instrument body, where the end portion 106 extends along the axis of rotation 103. In some embodiments, the socket 114 is threaded to receive a threaded end portion 106 of the control bar 102. In other embodiments, the socket 114 is configured for a snap-fit with end portion 106. When inserted into the socket 114, for example, the player can grip the arm portion 104 to rotate control bar 102 about end portion 106 and/or to pivot the tailpiece 110 about a pivot point or pivot axis 116 to change the tension on strings 64. In some embodiments, the pivot axis 116 is defined by screws or posts used to connect the tailpiece 110 to the guitar body 60.

FIG. 3B illustrates a front view of part of a guitar with a tailpiece system 100, in accordance with an embodiment of the present disclosure. In this example, the tailpiece 110 is a fixed tailpiece 110. The tailpiece system 100 includes a control bar 102 installed in a socket 114 located next to the tailpiece 110. In this example, the socket 114 extends into a cavity or bore in the guitar body 60 and is secured to a mounting plate 114a attached to the guitar body 60. In this example, the control bar 102 is not used to change the tension on the strings 64, but instead modulates a control signal when the user rotates the control bar 102 about the end portion 106 (not visible, shown, e.g., in FIG. 5) of the control bar 102.

In some embodiments of tailpiece system 100, the sensor circuit 200 (discussed below) is configured to change the control signal (e.g., for gain or attenuation) when the control bar 102 is within a predefined sector 90 of rotation between a first radius 92 and a second radius 94 from the axis of rotation 103. In one embodiment, sector 90 is 120° or less, including 90° or less, 45° or less, 30° or less, or some other angle. For example, a first radius 92 corresponds to a first value of control signal (e.g., a control signal corresponding to 20 dB of gain or attenuation when processed by sensor circuit 200) and a second radius 94 corresponds a second value of control signal (e.g., a control signal corresponding to 0 dB gain/attenuation). The control signal can gradually change as the control bar 102 is moved within the sector 90. The sector 90 may include regions of gain and/or attenuation as desired by adjusting settings of sensor circuit 200 and the position of sensor chip 142. In one embodiment, the first radius 92 extends from axis of rotation 103 away from the strings 64 (e.g., perpendicularly to the strings) and the second radius 94 extends generally along the strings 64. The sector 90 may be adjusted in size and position as desired. In some embodiments, the control bar 102 is operable through the full 360° of rotation about the axis of rotation 103.

Referring now to FIG. 4, a perspective illustration shows the tailpiece 110 of FIG. 3A with the end portion 106 of the control bar 102 inserted into the socket 114 defined in a vibrato block 118. As such, the control bar 102 can be used to adjust the tension on strings 64 (shown in FIG. 2) by pivoting the tailpiece 110, as discussed above. A permanent magnet 130 is mounted to end portion 106 of the control bar 102. When inserted into the socket 114, the magnet 130 is positioned sufficiently close to a sensor chip 142 that is responsive to changes in a magnetic field B as the magnet 130 moves in response to rotating the control bar 102. The sensor chip 142 can be secured in the socket 114, mounted to the vibrato block 118, mounted to the guitar body adjacent the socket 114, or secured at another location on the tailpiece 110. In one embodiment, the vibrato block 118 defines a sensor recess or sensor opening 120 to receive and retain a sensor chip assembly 140 that includes the sensor chip 142. In one embodiment, the sensor opening 120 is coaxially aligned with the socket 114 and extends through the bottom surface 118a of the vibrato block 118 towards the socket 114. In another embodiment, the sensor opening 120 is a bore through a back of the guitar body 60.

The sensor chip assembly 140 can be retained in the sensor opening 120 by any one of a variety of methods. For example, the sensor chip assembly 140 is adhered within the sensor opening 120, retained by an interference or pressure fit in the sensor opening 120, retained by threaded engagement, retained by a snap fit in sensor opening 120, retained using a set screw 141, or some other means. A set screw 141 extending through the vibrato block 118 and in contact with the sensor chip assembly 140 can be used to retain the sensor chip assembly 140 in the sensor opening 120 and to enable easy removal and adjustment of the sensor chip assembly 140, in accordance with some embodiments. For example, the axial position of the sensor chip assembly 140 in the sensor opening 120 can be adjusted after loosening the set screw 141.

Referring now to FIG. 5, a perspective illustration shows a portion of the control bar 102 and sensor chip assembly 140 of FIG. 4, in accordance with an embodiment. The magnet 130 is fixedly attached to the end portion 106 at or near the distal end 107 of the control bar 102 and spaced from the sensor chip 142 by a gap 150. In one embodiment, the magnet 130 is a rare-earth magnet (e.g., a neodymium or samarium-cobalt magnet) with a North pole 132 and a South pole 134 defining a magnetic field B oriented transversely (e.g., perpendicularly) to the axis of rotation 103 of the control bar 102. In some embodiments, the end portion 106 defines a recess 108 to receive the magnet 130. For example, the recess 108 is a notch or cut defined in the end portion 106 and is sized to receive the magnet 130. As illustrated in FIG. 5, for example, the South pole 134 abuts the recess 108 and the North pole 132 faces away from the recess 108. In other embodiments, the recess 108 is a flat or a slot machined into the distal end 107 of the end portion 106. In some embodiments, the magnet 130 is fixed to the distal end 107 of the end portion 106 using adhesive or the like.

In some embodiments, the sensor chip assembly 140 includes a support member 143 made of a non-conductive material, and the sensor chip 142 is attached to or retained by the support member 143. In one embodiment, the support member 143 generally has a cylindrical shape with a support member end 144, where the support member 143 is received in the sensor opening 120 with the support member end 144 facing the end portion 106 of the control bar 102. For ease of manufacturing, the sensor opening 120 can be a cylindrical bore and the support member 143 can be a cylinder or other suitable shape that is sized to be retained in sensor opening 120. In one embodiment, the support member 143 is a plastic cylinder with one or more channels 145 extending axially along an outside surface 143a and sized to receive a wire or wires 146 connected to sensor chip 142. For ease of mounting the sensor chip 142, the support member end 144 preferably is flat and square to the outside surface 143a (e.g., the flat end of a cylinder.) In other embodiments, electrical contacts of the sensor or wires 146 connected thereto extend through hollow conduit defined in the support member 143. In yet other embodiments, the support member 143 is a wad of adhesive, tape, foam, or other material that holds together wires 146 connected to the sensor chip 142 and retains the position of the sensor chip 142 relative to magnet 130.

The sensor chip 142 is spaced from the magnet 130 by a gap 150, which may be constant or variable. Optionally, the gap 150 is adjustable, such as when the sensor chip assembly 140 is retained in the sensor opening 120 by a set screw 141 or by threaded engagement. In some embodiments, the gap 150 is fixed and constant, where the sensor chip 142 detects only a change in direction of magnetic field B. The size of the gap 150 is determined by the size of magnet 130 and its magnetic field B, the type and sensitivity of the sensor chip 142, and other factors. Optionally, the user can change the size of the gap 150 as needed to adjust the performance of sensor circuit 200.

In some embodiments, it is desirable for the sensor chip 142 to operate in field saturation mode so that minor changes in the gap 150 have no effect on the amplitude of the control signal. For example, the sensor chip 142 is insensitive to changes in the size of the gap 150 due to vibration or changes in the gap 150 due to movement of the magnet 130 relative to sensor chip 142, as may occur during use of the control bar 102.

In one embodiment, the sensor chip 142 employs one or more methods of magnetic detection. For example, a change in the gap 150 between magnet 130 and sensor chip 142 affects the strength of the magnetic field B. Also, rotation of the magnet 130 results in a change in the direction of the magnetic field B. Field strength and/or field direction can be used to affect the control signal from sensor chip 142, and therefore to change volume or other effect parameter.

In one embodiment, the sensor chip 142 is sensitive to changes in field direction and utilizes a magneto-resistive bridge circuit such as the Honeywell HMC1501 chip. Based on the magnetic field B applied to the sensor chip 142, the rotation or angular position of the control bar 102 is converted into a voltage. In some embodiments, the voltage can be used to control the amplitude of the control signal using a voltage-controlled amplifier (VCA) set to have a maximum gain value. For example, the maximum gain value is one; other maximum gain values greater than one or less than one are also acceptable. The control signal amplifier 250 and the voltage-controlled amplifier 260 can be connected in series with the instrument's volume potentiometer 65, where the output or control signal from the sensor chip 142 can be used to control the instrument's output signal and/or to control an off-instrument effect, in accordance with some embodiments. In some embodiments, the control signal is provided to an off-instrument effects processor, such as a foot pedal, rack mounted effects processor, or other processor, where the amplitude of the control signal (e.g., voltage) is used to control an effect.

In some embodiments, the sensor chip 142 is sensitive to changes in magnetic field strength and uses a Hall Effect sensor, such as the Infineon 4997 chip that detects changes in magnetic field strength as the magnet 130 moves relative to sensor chip 142. As the gap 150 changes, the strength of magnetic field B changes. Accordingly, the sensor chip 142 outputs a control signal based on the strength of the magnetic field B applied to sensor chip 142. Thus, the sensor chip 142 is sensitive to changes in the magnetic field B and outputs a control signal that can be used to attenuate (or boost) the audio signal from the guitar's pickup(s) 69 and/or to change an effect parameter of an off-instrument effects processor.

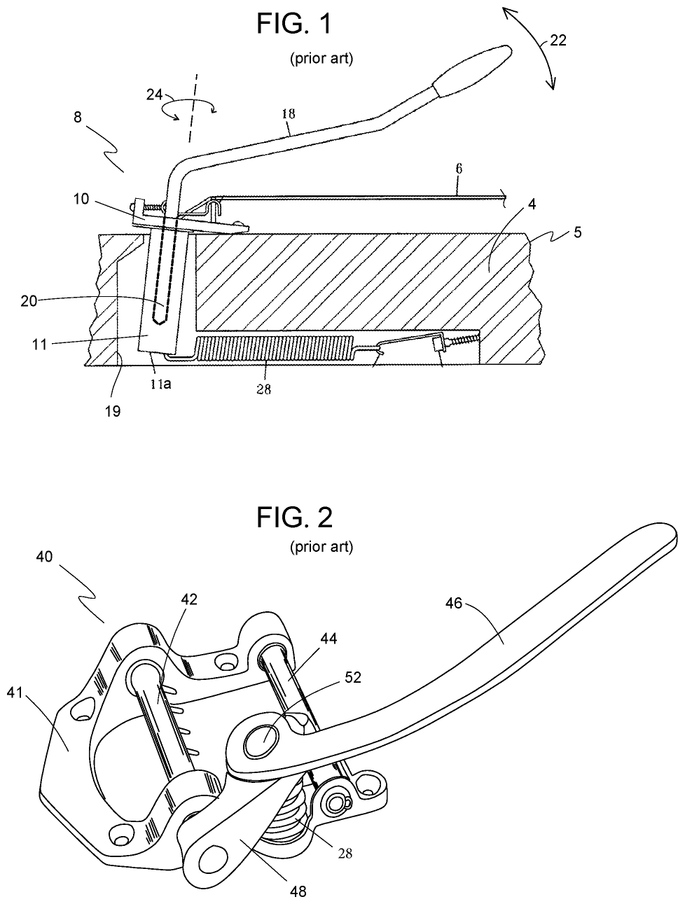

For example, the sensor chip 142 is a Hall Effect chip that is mounted on a sidewall 119 of vibrato block 118, to a wall of the guitar's cavity 19 (shown in FIG. 1), or a location on tailpiece 110 such that rotation of the control bar 102 about the axis of rotation 103 (and therefore rotation of magnet 130) changes the size of the gap 150 between the magnet 130 and the sensor chip 142. As the gap 150 increases, the strength of magnetic field B decreases. The sensor chip 142 detects this change in field strength and accordingly outputs a control signal that can be used to affect volume or a parameter of an effects processor, for example.

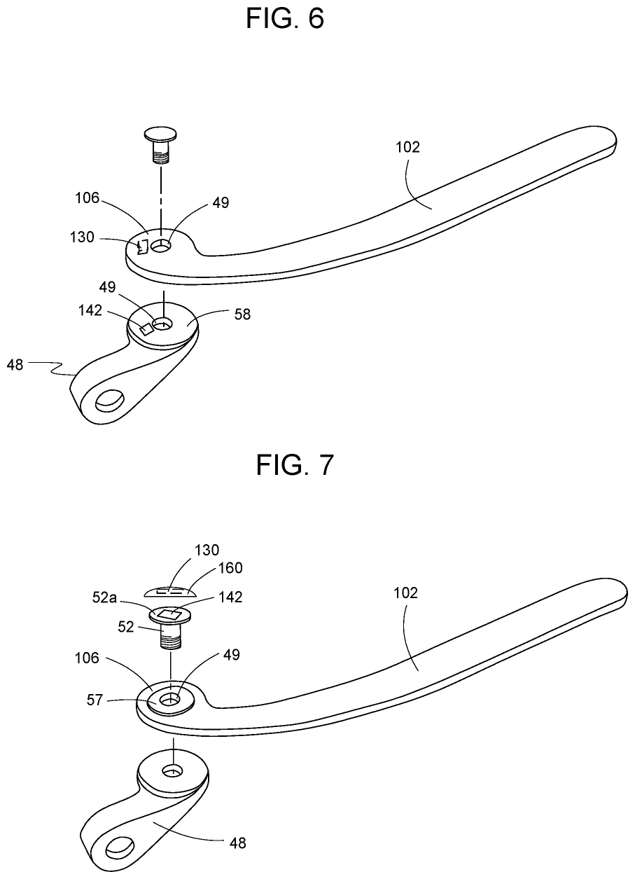

Referring now to FIG. 6, a top perspective view shows a control bar 102 and mounting bracket 48, in accordance with an embodiment of the present disclosure. The end portion 106 of the control bar 102 attaches to the mounting bracket 48 using a fastener 52 that allows rotation of the control bar 102 about the fastener opening 49 defined through the bar-attachment face 58. In one embodiment, the sensor chip 142 is embedded in or otherwise attached to the bar-attachment face 58 of the mounting bracket 48 and does not interfere with rotation of the control bar 102. The magnet 130 is embedded in or attached to a bottom face 106a of the end portion 106 and is positioned to align with the sensor chip 142 when the control bar 102 is in use. In one embodiment, the sensor chip 142 is immediately adjacent the fastener opening 49 to minimize the change in field strength as the control bar 102 rotates.

FIG. 7 illustrates a top perspective view of a control bar 102 and mounting bracket 48 of a tailpiece assembly, in accordance with another embodiment of the present disclosure. In this example, the sensor chip 142 is attached to an end 52a of a fastener 52. A magnet 130 is retained in a fastener cap or cover 160, where the cover 160 is installed onto the end portion 106 with the magnet 130 axially aligned with the sensor chip 142. For example, the cover 160 is secured to the end portion 106 by an engaging a lip that extends around the fastener opening 49 or some other feature on the end portion 106. The cover 160 can be made removable (e.g., a snap fit, a threaded attachment, or secured with fasteners), openable (e.g., hinged), or permanently attached over the end portion 106. As the control bar 102 rotates, spacers and washers 57 can be used to maintain the fastener 52 in a fixed position without rotating. Therefore, relative movement between the magnet 130 and the sensor chip 142 results in a change in magnetic field B.

In one embodiment, the magnet 130 is a pressed samarium/cobalt magnet, such as the Honeywell 103MG5 sensor magnet, which has dimensions of 2 mm×2 mm×1 mm thick and a room-temperature magnetic field B of about 1110 Gauss at 0.25 mm and 120 Gauss at 2.54 mm. Other magnets 133 may be used as appropriate for the available dimensions, the particular sensor chip 142, the size of gap 150, and other considerations.

Using the Honeywell 103MG5 magnet 130 with a magnetic displacement sensor, such as the Honeywell 1501/1512 sensor chip 142, a gap 150 of about 0.25 inch results in 50% field saturation and a gap 150 of about 0.15 inch results in full saturation. Accordingly, to ensure operation of the sensor chip 142 in full saturation, the gap 150 is preferably less than 0.15 inch, such as 0.10 inch. When the gap 150 is sized to result in less than full magnetic field saturation, changes in the gap 150 may affect the amplitude of the control signal from the sensor chip 142. In one embodiment where the gap 150 is sized to result in full saturation, the sensor chip 142 is configured to detect the direction of the magnetic field B resulting from the angular position or rotation of the magnet 130 about the axis of rotation 103. As the magnet 130 rotates about the axis of rotation 103, the direction of the magnetic field B changes and is detected by the sensor chip 142. Due to field saturation, the sensor chip 142 is insensitive to changes in the size of the gap 150 that may result from misalignment of the magnet 130 and the sensor chip 142, for example.

In yet another embodiment of tailpiece system 100, the sensor chip 50 detects the linear translation of the magnet 130. For example, the magnet 130 is attached to or retained by the arm portion 104 of the control bar 102 and the sensor chip 142 is retained in the guitar body 60. As the user moves the arm portion 104 across guitar body 60, the magnet 130 sweeps over the sensor chip 142, which detects the change in the strength of magnetic field B and/or a change in the direction of magnetic field B. An arc of about 30° corresponds to the typical range of rotational motion of the control bar 102, for example. Although the movement of the magnet 130 follows an arc in this example, sensor chip 142 is capable of detecting both linear and rotational translations of the magnet 130.

Referring now to FIGS. 8 and 9, circuit diagrams illustrate a sensor circuit 200 coupled to the sensor chip 142, in accordance with some embodiments. Sensor circuit 200 includes a voltage source or battery 210, a virtual ground 220, a voltage regulator 240, a control signal amplifier 250, a voltage-controlled amplifier 260, and a current-voltage converter 270.

The sensor chip 142 outputs a control signal 280 based on the magnetic field B. The control signal 280 can be a voltage signal with amplitude determined at least in part by the strength and/or direction of magnetic field B. In the diagram of FIG. 8, the control signal 280 is output from pins 1 and 8 of the sensor chip 142 and is provided to the control signal amplifier 250. However, depending on the value of the control signal 280, the control signal amplifier 250 may not be necessary, and therefore is optional in some embodiments.

For controlling the instrument's volume or tone, for example, the amplified control signal 281 can be directed to the voltage-controlled amplifier 260 to change the amplitude of the instrument's audio signal.

For controlling off-instrument effects or other signal processor separate from the instrument, the control signal 280 or amplified control signal 281 can be directed to the instrument's output 68 (e.g., a stereo ¾″ audio jack), and then to the effects processor via an instrument cable, for example. In some embodiments, an optional switch 282 can be used to select “on” states for instrument signal control, off-instrument processor control, both, or neither (e.g., off), as will be appreciated. In some embodiments, the control signal 280 (or amplified control signal 281) has a value from 0 to 3.3 volts, as is typical of some analog-to-digital inputs. In other embodiments, the control signal 280 (or amplified control signal 281) is from 0 to 5 volts, from 5 to 10 volts, or some other suitable value. In some embodiments, the amplitude of the amplified control signal 281 can be adjusted, such as with a trim pot or the like.

The sensor circuit 200 illustrated in FIG. 8 utilizes a magneto-resistive sensor chip 142, such as the Honeywell HMC1501 or HMC1512. The magneto-resistive sensor chip 142 detects the direction of magnetic field B. In contrast, the sensor circuit 200 in FIG. 9 utilizes a Hall Effect sensor chip 142, such as the Infineon 4997. Sensor circuits 200 in both FIGS. 8-9 can be configured for use with a 9 v battery 210 or equivalent power supply. Other power sources or batteries 210 may be used as desired. In some embodiments, the sensor circuit 200 is designed to have a maximum gain of 1.0. The sensor circuit 200 can be configured for other gains greater than or less than 1.0.

In some embodiments as shown in FIGS. 8-9, a battery 210 is connected to pins 2 and 3 of the virtual ground 220 (a.k.a. “rail splitter”) where ˜9 v from the battery 210 becomes voltage outputs of about +4.5 v, −4.5 v, and a virtual ground at 0 v. The output voltage is used to power other devices at the v+ and v− connections, where v+ is about 4.5 volts and v− is about −4.5 volts. The virtual ground signal of pin 1 connects to earth and to the ground on each block of the sensor circuit 200. The positive voltage (e.g., +4.5 v) at pin 3 and virtual ground at pin 1 is the voltage used to power the sensor chip 142; the positive voltage at pin 3, virtual ground at pin 1, and negative voltage at pin 2 are used to power the control signal amplifier 250, voltage-controlled amplifier 260, and current-voltage converter 270. Other batteries 210 or voltage sources are acceptable provided that the voltage difference between voltage outputs is sufficient to operate the circuit (typically ±2.5 volts or greater). A larger supply voltage from the battery 210 provides a larger control signal generated by sensor chip 142, as can be appreciated.

Voltage regulator 240 is an optional block in sensor circuit 200 and is used to provide a steady voltage to the sensor chip 142 and other components so as to minimize unwanted changes in gain. The voltage regulator 240 is more desirable when the sensor chip 142 is a Hall Effect sensor, such as shown in FIG. 9, to address decreasing voltage of the battery 210 over time; this change in voltage from the battery 210 can affect the operation of the sensor circuit 200.

In one embodiment, the voltage regulator 240 is a Fairchild LM7805 chip. For various orientations of the magnet 130, one can control the gain sensitivity of the control signal amplifier 250 for a given position of the control bar 102 by changing the gain resistor R1 across the AD622 chip and/or adjusting the trim pot R2, which sets the offset or reference voltage delivered to VCA 260.

As discussed above, the sensor chip 142 uses magnetoresistance and an applied magnetic field B to deliver a control signal 280 to control signal amplifier 250 where the voltage is amplified before being sent to pin 3 of the voltage-controlled amplifier (VCA) 260 as the control current Ec−. In some embodiments, the resistance of the sensor chip 142 changes due to the strength of magnetic field B, resulting in different values of the control signal 280. In other embodiments, the sensor chip 142 uses anisotropic magnetoresistance, where the resulting control signal 280 is based at least in part on the direction of magnetic field B.

In embodiments using the Honeywell HMC 1501/1512 magneto-resistive sensor chip 142, such as shown in FIG. 8, the control signal amplifier 250 preferably includes an Analog Devices 622 chip. The control signal amplifier 250 amplifies the voltage of the control signal 280 received from the sensor chip 142 so an amplified control signal 281 can be used by VCA 260 to adjust the amplitude of the audio signal received from the instrument pickup(s) 69, in accordance with some embodiments. Gain of control signal amplifier 250 is set by resistor R1, which at 20KΩ is about 3.5 and at 10KΩ is about 6. A gain of 6 results in a predefined sector 90 (shown in FIG. 3) with an angular range of about 30°. The trim pot resistor R2 provides an offset voltage that controls the maximum gain of the sensor circuit 200 throughout the entire 360° of control bar 102.

In some embodiments, output from pin 6 of AD622 chip in control signal amplifier 250 is typically between 0 v and 0.7 v when the amplified control signal 281 is used to control the instrument's volume. The amplified control signal 282 is delivered to pin 3 of the THAT 2181 chip in VCA 260. Gain of VCA 260 can be set based on the voltage received from control signal amplifier 250 and can be used to adjust the instrument's audio signal from pickup(s) 69 delivered to pin 1 of THAT 2181 in VCA 260. For example, an amplified control signal 280 with voltage of 0 v from control signal amplifier 250 results in a gain of 1 for VCA 260; a voltage of 0.7 v from the control signal amplifier 250 results in attenuation of 20 dB to 30 dB by VCA 260. The output signal of VCA 260 is converted from current to voltage by current-voltage converter 270 and then delivered to the instrument's output connector 38 (shown in FIG. 3.)

In one embodiment, VCA 260 is a THAT 2181 chip with wide dynamic range, low distortion, and low noise suitable for high-performance audio applications. The THAT 2181 requires a supply voltage of about ±4 v or greater. VCA 260 converts the instrument's audio signal from pickup(s) 69 to current, then amplifies and modulates the current signal. Other models of VCA 260 are acceptable to provide an output voltage to instrument output 38 connector that is between about 100 mv and 1 v RMS typical of instrument-level audio signals. As is typically used for audio applications, an output signal of up to about 300 mv is considered “instrument level” for −10 dB inputs and about 1.2 v is considered “line level” for +4 dB inputs. Thus, the gain of VCA 260 may be chosen to deliver the desired output signal level from the instrument.

Current-voltage converter 270 converts the current signal output from VCA 260 back to voltage for delivery to the instrument's output connector 38. Resistors R3 (20 KΩ) in current-voltage converter 270 and R4 (20 KΩ) at the input to VCA 260 are recommended to optimize competing values of bandwidth and noise; other resistor values can be used as needed for a desired bandwidth or noise level. In one embodiment, current-voltage converter 270 is an OP275 chip made by Analog Devices. The OP275 chip requires a minimum supply voltage of ±4.5 volts. Other op amps are acceptable, including the Analog Devices OP90, which has a minimum supply voltage of ±2.6 volts. Another acceptable op amp is the NJM4580D made by National Japan Radio Company, which is especially suited to audio applications and also operates with a lower minimum supply voltage compared to the OP275.

Optionally, an input capacitor C3 of 10 μF isolates the sensor circuit 200 from external DC sources, and input resistor R4 of 20 KΩ provides the desired input resistance. Resistors R7 and R8 in the control signal amplifier 250 of FIG. 9 are also optional, but these resistors are useful to protect the AD622 chip from over current. Capacitor C4 in the control signal amplifier 250 shunts AC feedback voltage from the audio signal and prevents any AC voltage from modulating VCA 260, which should receive only DC control voltage as a result of moving the control bar 102. Capacitor Cl in virtual ground 220 is optional and is useful to remove ripples in the supply voltage coming from an AC-powered voltage supply.

Referring to FIG. 9, an example of sensor circuit 200 is shown for sensor chip 142 configured as a Hall Effect sensor. For example, sensor chip 142 is the TLE 4997 linear Hall Effect sensor by Infineon. Battery 210, virtual ground 220, voltage regulator 240, VCA 260, and current-voltage converter 270 are configured and function as described above with reference to FIG. 8. Since the connections and output (about 1 mA) are different for the Infineon TLE 4997 sensor chip 142, the control signal amplifier 250 utilizes the LM 741 amplifier by Texas Instruments or some other suitable general-purpose operational amplifier. Output voltage of the TLE 4997 varies linearly with supply voltage and with the applied magnetic field B. Using an input voltage of +4.5 v, for example, the control signal output from TLE 4997 sensor chip 142 varies from 0 v to +4.5 v depending on orientation and strength of magnetic field B. As with the sensor circuit 200 discussed above with reference to FIG. 8, the output signal from pin 6 of control signal amplifier 250 is current Ec− delivered to pin 3 of VCA 260 and determines the gain of VCA 260.

In another embodiment, the control bar 102 provides volume control where the sensor chip 142 is an optical sensor fixed to the guitar body 60, a pickguard (not shown) attached to the guitar body 60, the control bar 102, the tailpiece 110, or some other location on the instrument. The sensor chip 142 is an optical sensor that detects or tracks movement of the control bar 102 and adjusts the instrument's output volume based on the position of the control bar 102. For example, the sensor chip 142 is an optical sensor positioned on the guitar between bridge pickup 69b and volume potentiometer 65 and uses a change in light intensity to detect the position of arm portion 104 of control bar 102. When arm portion 104 is positioned proximate the lower edge of bridge pickup 35a, for example, volume is not attenuated; when arm portion 104 is positioned over master volume potentiometer 31 or is further rotated towards the lower edge of guitar body 60, the volume is attenuated by an amount from 0 dB and 30 dB.

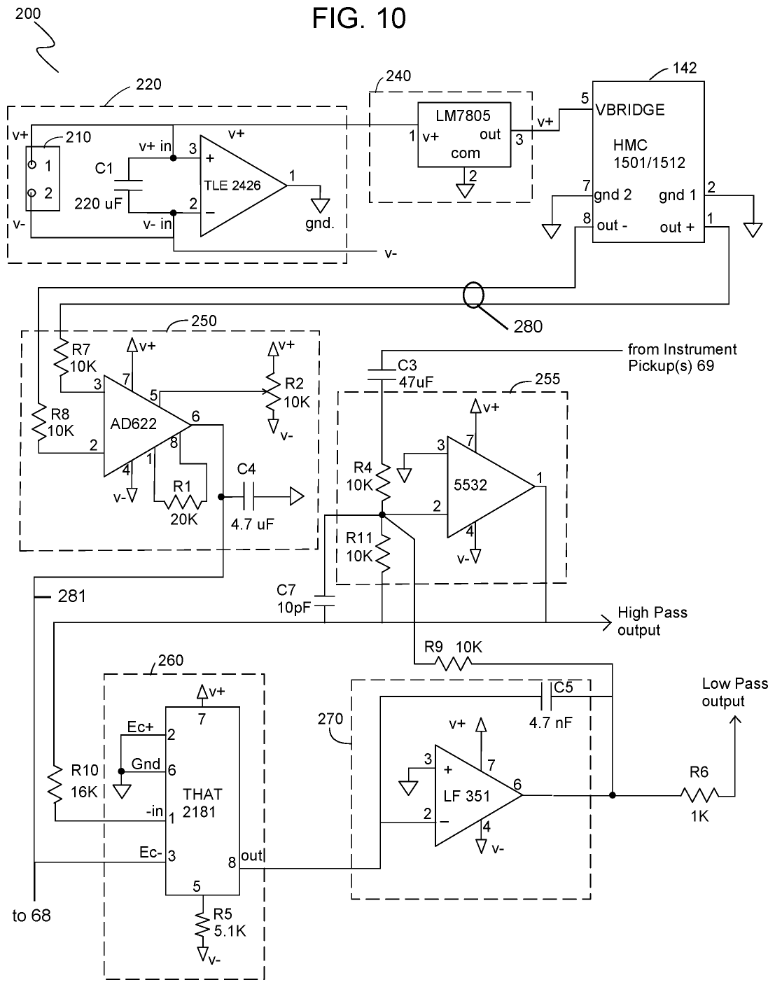

Referring now to FIG. 10, a circuit diagram is illustrated for adjusting the tone, in accordance with an embodiment of the present disclosure. Similar to other embodiments discussed above, sensor circuit 200 of FIG. 10 can be modified or otherwise configured to send an amplified control signal 281 to the output 68 of the instrument, such as for controlling a separate effects processor.

Sensor circuit 200 of FIG. 10 includes sensor chip 142, battery 210, voltage regulator 240, and virtual ground 220 as discussed above with reference to FIG. 8, where the control voltage from the sensor chip 142 is measured between output pin 1 and output pin 8 of the sensor chip 142 (e.g., Honeywell 1501.) Circuit 200 has two outputs, namely, a low pass output and a high pass output. The sensor circuit 200 adds op amp 255 (e.g., Texas Instruments NE5532), which in combination with THAT 2181 of voltage-controlled amplifier 260 and op amp in block 270 (e.g., Texas Instruments LF 351) comprise a filtering/feedback circuit 290. A high pass/low pass filtering effect is obtained by the op amp feedback together with the selection of R10 (16 KΩ) and capacitor C5 (4.7 nF). The frequency range over which filtering occurs is determined by filtering in the audio range. The gain of the voltage-controlled amplifier 260 (THAT 2181 chip) is controlled by movement of the control bar 102 and the resulting output of the sensor chip 142. The variable gain provides a variable filter cutoff range or a variable tone control circuit. Op amps LF351 and NE5532 are selected for having low noise, low distortion, and desirable bandwidth characteristics. The sensor circuit 200 of FIG. 10 can enable one to generate a “wah” effect controlled by control bar 102.

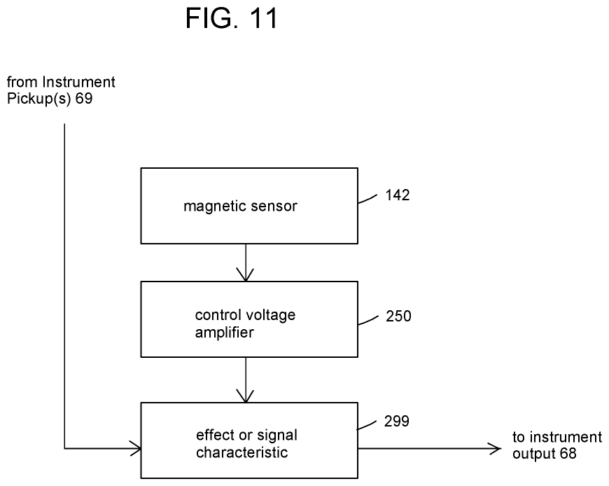

Referring now to FIG. 11, a flow diagram illustrates a method 400 of adjusting an instrument output signal, in accordance with one embodiment. A signal is received from instrument pickup(s) 69 into a circuit block 299, which may be voltage-controlled amplifier 260 (for volume control), filtering/feedback circuit 290 (for tone control), or other effect or change to the instrument's signal from pickup(s) 69. Based on a detected magnetic field B, the sensor chip 142 outputs a control voltage that is amplified as needed by the control signal amplifier 250. The magnitude of the control voltage from the sensor chip 142 is used to determine the change to the instrument's audio signal, which is then output to instrument output 68.

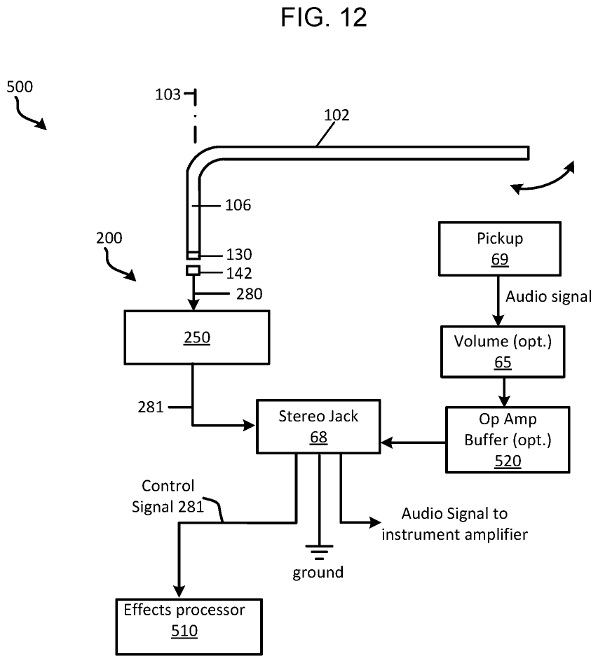

Referring now to FIG. 12, a method 500 of controlling an off-instrument effects processor is shown, in accordance with an embodiment of the present disclosure. The control bar 102 is provided and installed in the stringed instrument such that a magnet 130 on the end portion 106 of the control bar 102 is sufficiently close to a sensor chip 142, as discussed above. Rotation of the control bar 102 about the axis of rotation 103 causes a change in the magnetic field B of the magnet 130 with respect to sensor chip 142. The sensor chip 142 outputs a control signal 280 based on the position, strength, polarity, or other property of the magnetic field. The signal from the sensor chip 142 is provided to the sensor circuit 200 and is amplified as needed to be within a suitable range for input to an effects processor 510, for example. Examples of the sensor circuit 200 are discussed above. The amplified control signal 281 is fed to the instrument's output 68, such as one pin of a stereo audio jack. Note that the term “amplified control signal” used herein is not limited to amplification and includes both amplification or attenuation to change the amplitude of the control signal 280 as needed (if at all) to be within an acceptable range, as will be appreciated.

The instrument's audio signal from the pickup(s) 69 can also be fed to the output 68, such as to another pin of a stereo audio jack. Optionally, the instrument's audio signal is buffered to reduce noise. In one such embodiment, the buffer 520 is an op-amp buffer placed between the volume potentiometer 65 and the output 68. In other embodiments, the instrument is configured with separate output jacks—one for audio and the other for a control signal.

The control signal 281 can be fed to an effects processor 510, which can be a volume pedal, an effects pedal, a rack-mounted effects processor, an effects processor in a guitar amplifier, or other signal processor that is separate from the instrument and that can be controlled using control signal 281. For example, the control signal is provided to the effects processor via an expression pedal input or other suitable means. The control signal 281 can be used to change a parameter of an effect, such as volume, on/off, chorus depth or rate, delay length, reverb length, pitch modulation, effect blend, or any other effect, as will be appreciated. In one embodiment, a cable has a stereo jack on one end that is plugged into the stereo output 68 jack of the instrument. The cable can be split into two mono cables, a first cable that can be used for connecting the control signal 281 to the effects processor 510 or expression pedal input, for example. The second cable can be used for connecting the audio signal to a guitar amplifier or the like. In other embodiments, separate cables can be used for the audio signal and the control signal, each of which can be plugged into a separate output 68 jack on the instrument. In yet another embodiment, the control signal 281 is communicated wirelessly to a receiver on the effects processor or the like, such as using near field communication, blue tooth, or other suitable wireless communication protocol. Numerous variations and embodiments will be apparent in light of the present disclosure.

In some embodiments, a control bar assembly of the present disclosure provides a player of stringed instruments, especially electric guitars, the ability to change the volume and pitch at the same time by changing the position of the control bar 102. In other embodiments, the control bar 102 can be used to control tone of the instrument's audio signal, such as by rotating the control bar 102 about the axis of rotation 103. In yet other embodiments, the rotational position of the control bar 102 changes the value of a control signal that can be supplied from the instrument to an off-instrument effects processor.

Various embodiments of the present disclosure can be provided as a retrofit kit for electric guitars or other stringed instruments, as a complete stringed instrument including the tailpiece and control bar assembly, or other configurations.

### FURTHER EXAMPLE EMBODIMENTS

The following examples pertain to further embodiments, from which numerous permutations and configurations will be apparent.

Example 1 is a method of controlling an off-instrument signal processor. In one embodiment, the method comprises providing a stringed instrument that includes an instrument body, an output jack in the instrument body, a socket extending into a top face of the instrument body, and a sensor circuit in the instrument body, where the sensor circuit comprises a sensor chip configured to output a control signal based on a magnetic field; providing a control bar having a user portion, an end portion extending transversely from the user portion, and a magnet on the end portion of the control bar, wherein the magnet has a magnetic field with a field direction; installing the end portion of the control bar into the socket such that the magnet is sufficiently close to the sensor chip to detect a change in the magnetic field upon rotation of the control bar about the end portion; outputting, by the sensor circuit, the control signal, wherein an amplitude of the control signal is based on a position of the magnet relative to the sensor chip; and controlling a parameter of an off-instrument signal processor using the control signal.

Example 2 includes the subject matter of Example 1, wherein controlling the parameter of the off-instrument signal processor includes providing the control signal via the output jack.

Example 2 includes the subject matter of Example 2, wherein the output jack is a stereo output jack that includes a first pin for the control signal and a second pin for an audio signal from the stringed instrument.

Example 4 includes the subject matter of Example 1, wherein controlling the parameter of the off-instrument signal processor includes wirelessly providing the control signal to the off-instrument signal processor.

Example 5 includes the subject matter of any of Examples 1-4, wherein the off-instrument signal processor is also coupled to an audio output of the stringed instrument, wherein the off-instrument signal processor is selected from an effects pedal, a rack effects unit, and an effects processor integral to a guitar amplifier.

Example 6 includes the subject matter of any of Examples 1-5 and further comprises rotating the control bar about the end portion, the sensor circuit detecting a change in the magnetic field resulting from rotating the control bar, and the sensor circuit modifying the amplitude of the control signal based on the change in the magnetic field.

Example 7 includes the subject matter of any of Examples 1-6, wherein the sensor chip is configured to detect a field direction and/or a field strength of the magnetic field.

Example 8 includes the subject matter of Example 7, wherein providing the stringed instrument includes selecting the sensor chip as configured for anisotropic magnetoresistance, and wherein the control signal is based on a direction of the magnetic field.

Example 9 includes the subject matter of Example 7, wherein the sensor circuit is configured to adjust the amplitude of the control signal based on a gap between the sensor chip and the magnet.

Example 10 is an electric guitar comprising an instrument body, an output jack in the instrument body, a control bar socket extending into a top face of the instrument body, and a sensor circuit in the instrument body, wherein the sensor circuit comprises a sensor chip configured to output a control signal based on a magnetic field; a control bar that has a user portion and an end portion connected to and extending transversely from the user portion, the end portion configured to be received in the control bar socket and rotatable about an axis of rotation; a permanent magnet on the end portion of the control bar, wherein the permanent magnet has a magnetic field; and a sensor circuit that includes a sensor chip positioned sufficiently close to the permanent magnet when the control bar is installed in the control bar socket, the sensor circuit configured to detect a change in the magnetic field resulting from rotating the control bar, wherein the sensor circuit is configured to output a control signal based on a position of the permanent magnet relative to the sensor chip.

Example 11 includes the subject matter of Example 10, and further comprises a tailpiece defining the control bar socket, the tailpiece secured to the instrument body.

Example 12 includes the subject matter of Example 10 or 11, wherein the output jack is a stereo output jack including a first pin for an audio signal of the electric guitar and including a second pin for the control signal.

Example 13 is a tailpiece assembly for a stringed instrument, the assembly comprising a control bar with an end portion and a user portion; a tailpiece defining a socket constructed to receive the end portion of the control bar such that the control bar is rotatable about the end portion when the end portion of the control bar is installed in the socket; a magnet on the end portion of the control bar, the magnet defining a magnetic field, wherein rotating the control bar rotates the magnet; a sensor chip adjacent the socket, the sensor chip configured to output a control signal based on a change in the magnetic field, wherein when the end portion of the control bar is installed in the socket, the sensor chip is spaced from the magnet by a gap sufficiently small to enable the sensor chip to detect a change in the magnetic field as a result of rotating the end portion of the control bar; a sensor circuit coupled to the sensor chip and configured to output a control signal that can be modulated by rotating the control bar about the end portion; a power supply coupled to the sensor circuit; and an output for the control signal.

Example 14 includes the subject matter of Example 13, wherein the sensor chip is at a bottom of the socket.

Example 15 includes the subject matter of Example 13 or 14, wherein the output is a stereo jack including an audio signal of the stringed instrument and the control signal of the sensor circuit.

Example 16 includes the subject matter of Example 13 or 14, wherein the output comprises a transmitter configured to transmit the control signal.

Example 17 is a retrofit kit for a guitar configured to output an audio signal, the retrofit kit comprising a mounting plate; a control bar with an end portion including a permanent magnet defining a magnetic field; a socket mounted to the mounting plate, the socket sized and configured to receive the end portion of the control bar such that the control bar is rotatable about the end portion, the socket including a sensor chip configured to detect a change in the magnetic field as a result of rotating the end portion in the socket; a sensor circuit coupled to the sensor chip, the sensor circuit configured to output a control signal based on a position of the permanent magnet relative to the sensor chip; and a means for outputting the control signal separately from the audio signal of the guitar, the means for outputting the control signal electrically coupled to the sensor circuit. In some embodiments, the guitar can be an electric six-string guitar or an electric bass guitar.

Example 18 includes the subject matter of Example 17, wherein the sensor circuit includes a transmitter configured to wirelessly output the control signal.

Example 19 includes the subject matter of Example 17, and further comprises a stereo output jack including a first pin for the audio signal of the guitar and a second pin for the control signal, and instructions for replacing an existing output jack with the stereo output jack, connecting the audio output to the first pin, and connecting the control signal to the second pin.

Example 20 includes the subject matter of Example 19, and further comprises a combination instrument and control cable comprising a stereo male jack, a first cable extending from the stereo male jack to a first mono male jack, and a second cable extending from the stereo male jack to a second mono male jack.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

We claim:

1. A method of controlling an off-instrument signal processor, the method comprising:
providing a stringed instrument comprising:
an instrument body;
an output jack in the instrument body;
a socket extending into a top face of the instrument body; and
a sensor circuit in the instrument body, the sensor circuit comprising a sensor chip configured to output a control signal based on a magnetic field;
providing a control bar having a user portion, an end portion extending transversely from the user portion, and a magnet on the end portion of the control bar, wherein the magnet has a magnetic field with a field direction;
installing the end portion of the control bar into the socket such that the magnet is sufficiently close to the sensor chip to detect a change in the magnetic field upon rotation of the control bar about the end portion;
outputting, by the sensor circuit, the control signal, wherein an amplitude of the control signal is based on a position of the magnet relative to the sensor chip; and
controlling a parameter of an off-instrument signal processor using the control signal.

2. The method of claim 1, wherein controlling the parameter of the off-instrument signal processor includes providing the control signal via the output jack.

3. The method of claim 2, wherein the output jack is a stereo output jack that includes a first pin for the control signal and a second pin for an audio signal from the stringed instrument.

4. The method of claim 1, wherein controlling the parameter of the off-instrument signal processor includes wirelessly providing the control signal to the off-instrument signal processor.

5. The method of claim 1, wherein the off-instrument signal processor is also coupled to an audio output of the stringed instrument, wherein the off-instrument signal processor is selected from an effects pedal, a rack effects unit, and an effects processor integral to a guitar amplifier.

6. The method of claim 1 further comprising:
rotating the control bar about the end portion;
the sensor circuit detecting a change in the magnetic field resulting from rotating the control bar; and
the sensor circuit modifying the amplitude of the control signal based on the change in the magnetic field.

7. The method of claim 1, wherein the sensor chip is configured to detect a field direction and/or a field strength of the magnetic field.

8. The method of claim 7, wherein providing the stringed instrument includes selecting the sensor chip as configured for anisotropic magnetoresistance, and wherein the control signal is based on a direction of the magnetic field.

9. The method of claim 7, wherein the sensor circuit is configured to adjust the amplitude of the control signal based on a gap between the sensor chip and the magnet.

10. An electric guitar comprising:
an instrument body;
an output jack in the instrument body;
a control bar socket extending into a top face of the instrument body; and
a sensor circuit in the instrument body, the sensor circuit comprising a sensor chip configured to output a control signal based on a magnetic field;
a control bar that has a user portion and an end portion connected to and extending transversely from the user portion, the end portion configured to be received in the control bar socket and rotatable about an axis of rotation;
a permanent magnet on the end portion of the control bar, wherein the permanent magnet has a magnetic field; and
a sensor circuit that includes a sensor chip positioned sufficiently close to the permanent magnet when the control bar is installed in the control bar socket, the sensor circuit configured to detect a change in the magnetic field resulting from rotating the control bar, wherein the sensor circuit is configured to output a control signal based on a position of the permanent magnet relative to the sensor chip.

11. The electric guitar of claim 10, further comprising a tailpiece defining the control bar socket, the tailpiece secured to the instrument body.

12. The electric guitar of claim 10, wherein the output jack is a stereo output jack including a first pin for an audio signal of the electric guitar and including a second pin for the control signal.

13. A tailpiece assembly for a stringed instrument, the assembly comprising:
a control bar with an end portion and a user portion;
a tailpiece defining a socket constructed to receive the end portion of the control bar such that the control bar is rotatable about the end portion when the end portion of the control bar is installed in the socket;
a magnet on the end portion of the control bar, the magnet defining a magnetic field, wherein rotating the control bar rotates the magnet;
a sensor chip adjacent the socket, the sensor chip configured to output a control signal based on a change in the magnetic field, wherein when the end portion of the control bar is installed in the socket, the sensor chip is spaced from the magnet by a gap sufficiently small to enable the sensor chip to detect a change in the magnetic field as a result of rotating the end portion of the control bar;
a sensor circuit coupled to the sensor chip and configured to output a control signal that can be modulated by rotating the control bar about the end portion;
a power supply coupled to the sensor circuit; and
an output for the control signal.

14. The assembly of claim 13, wherein the sensor chip is at a bottom of the socket.

15. The assembly of claim 13, wherein the output is a stereo jack including an audio signal of the stringed instrument and the control signal of the sensor circuit.

16. The assembly of claim 13, wherein the output comprises a transmitter configured to transmit the control signal.

17. A retrofit kit for a guitar configured to output an audio signal, the retrofit kit comprising:
a mounting plate;
a control bar with an end portion including a permanent magnet defining a magnetic field;
a socket mounted to the mounting plate, the socket sized and configured to receive the end portion of the control bar such that the control bar is rotatable about the end portion, the socket including a sensor chip configured to detect a change in the magnetic field as a result of rotating the end portion in the socket;
a sensor circuit coupled to the sensor chip, the sensor circuit configured to output a control signal based on a position of the permanent magnet relative to the sensor chip; and
a means for outputting the control signal separately from the audio signal of the guitar, the means for outputting the control signal electrically coupled to the sensor circuit.

18. The retrofit kit of claim 17, wherein the sensor circuit includes a transmitter configured to wirelessly output the control signal.

19. The retrofit kit of claim 17, further comprising:
a stereo output jack including a first pin for the audio signal of the guitar and a second pin for the control signal; and
instructions for replacing an existing output jack with the stereo output jack, connecting the audio output to the first pin, and connecting the control signal to the second pin.

20. The retrofit kit of claim 19, further comprising a combination instrument and control cable comprising a stereo male jack, a first cable extending from the stereo male jack to a first mono male jack, and a second cable extending from the stereo male jack to a second mono male jack.
